(19) United States
(12) Patent Application Publication
(10) Pub. No.: US 2026/0212469 A1
(43) Pub. Date: Jul. 23, 2026

(54) HIGH DYNAMIC IMAGE GENERATION

(71) Applicant: QUALCOMM Incorporated, San Diego, CA (US)

(72) Inventors: Jianyou Li, San Diego, CA (US); Jiafu Luo, Irvine, CA (US); Xiaoyun Jiang, San Diego, CA (US); Tao Ma, San Diego, CA (US)

(21) Appl. No.: 19/029,003

(22) Filed: Jan. 17, 2025

(51) Int. Cl. G06T 5/92; G06T 5/50

(52) U.S. Cl. CPC G06T 5/92; G06T 5/50; G06T 2207/20208

(57) ABSTRACT

A device for image processing includes one or more memories; and processing circuitry configured to: receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receive a second image generated with a second exposure duration, the second exposure duration being greater than the first exposure duration; generate a first high dynamic range (HDR) image based on the first image and second image; output the first HDR image; receive a third image generated using the DCG mode with the first exposure duration; generate a second HDR image based on the third image and the second image; and output the second HDR image.

### TECHNICAL FIELD

The disclosure relates to image processing.

### BACKGROUND

A camera processor can generate a high dynamic range (HDR) image by combining multiple images that are captured at different exposure durations. Due to different exposure durations, the image content in the multiple images may be different, such as due to movement of an object captured in one image but not the other. One of the images may function as an anchor image, such that if there is difference in image content, image content from the anchor image is used for purposes of generating the HDR image.

### SUMMARY

In general, this disclosure describes techniques for generating a high dynamic range (HDR) image fusing a first image generated with dual conversion gain (DCG) mode with a first exposure duration, and a second image generated with a second exposure duration that is greater than the first exposure duration. The first image and the second image may be captured over a frame time (e.g., generated, output, or readout over a frame time). Due to the different exposure durations and/or images possibly being captured at different times, motion can cause discrepancies in image content between the first and second images. A camera processor selects one of the images as an anchor image for fusing. That is, where there is discrepancy in image content between the first and second images, the camera processor may select image content from the anchor image for fusing. If the anchor image is captured at a lower resolution or skipped for power savings, visual artifacts can occur.

In one or more examples, for each frame time, the camera processor may select the image generated with DCG mode with the first exposure duration as the anchor image. In this way, generation of the second image used for fusing may be skipped or may be generated with a lower resolution with less visual artifact impact for power saving. Accordingly, the example techniques may improve the technology of generating HDR images based on using DCG mode images as anchor images that are generated with a shorter exposure duration compared to an exposure duration of the other images used for generating HDR images.

In one example, the disclosure describes a device for image processing, the device comprising: one or more memories; and processing circuitry coupled to the one or more memories and configured to: receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receive a second image generated with a second exposure duration, the second exposure duration being greater than the first exposure duration; generate a first high dynamic range (HDR) image based on the first image and second image; output the first HDR image; receive a third image generated using the DCG mode with the first exposure duration; generate a second HDR image based on the third image and the second image; and output the second HDR image.

In one example, the disclosure describes a method of image processing, the method comprising: receiving, with processing circuitry, a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receiving, with the processing circuitry, a second image generated with a second exposure duration, the second exposure duration being greater than the first exposure duration; generating, with the processing circuitry, a first high dynamic range (HDR) image based on the first image and second image; outputting, with the processing circuitry, the first HDR image; receiving, with the processing circuitry, a third image generated using the DCG mode with the first exposure duration; generating, with the processing circuitry, a second HDR image based on the third image and the second image; and outputting, with the processing circuitry, the second HDR image.

In one example, the disclosure describes non-transitory computer-readable storage media storing instructions thereon that when executed cause one or more processors to: receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receive a second image generated with a second exposure duration, the second exposure duration being greater than the first exposure duration; and generate a first high dynamic range (HDR) image based on the first image and second image; output the first HDR image; receive a third image generated using the DCG mode with the first exposure duration; generate a second HDR image based on the third image and the second image; and output the second HDR image.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a block diagram illustrating an example image sensor configured to perform one or more of the example techniques described in this disclosure.

FIGS. 3A and 3B are conceptual diagrams illustrating examples of frame times and exposure durations of images captured during the frame times.

FIGS. 4A and 4B are conceptual diagrams illustrating examples fusion of different images for generating high dynamic range (HDR) images.

FIG. 5 is a flowchart illustrating an example method of operation.

FIG. 6 is another flowchart illustrating an example method of operation.

### DETAILED DESCRIPTION

A camera processor is configured to generate a high dynamic range (HDR) image by fusing at least two images captured at different exposure durations. One image is captured using a relatively long exposure duration as compared to the other image that is captured using a short exposure duration. The exposure duration refers to how long an image sensor is exposed to light while capturing an image. Due to the different exposure durations and/or due to the images possibly being captured at different times, if there is motion, the image content in the different images may be different. During the fusing process to generate the HDR image, a camera processor selects one of the images as an anchor and selects content from that image for fusing if there is a discrepancy in image content.

For power savings, capturing one of the images may be skipped, or one of the images may be captured at a lower resolution. If this image is used as the anchor image, there can be visual artifacts. For example, if capturing of the anchor image is skipped, then a previously captured anchor image is used, and there may be even more discrepancy between the anchor image and the other image used for generating the HDR image due to the longer time gap between the re-used anchor image and the other image. If the anchor image has lower resolution, then there may loss of resolution in the image content (e.g., fuzzier image content). Using the previously captured anchor image or lower resolution anchor image may result in image artifacts when generating the HDR image.

This disclosure describes example techniques to achieve power savings from skipping capturing of images or from capturing lower resolution images while minimizing visual artifacts. As described in more detail, a camera processor may receive a first image generated using a dual conversion gain (DCG) mode. In DCG mode, an image sensor may generate a first gain image by providing a first level of gain to the photodiodes of the image sensor and generate a second gain image by providing a second, lower level of gain to the photodiodes. The image sensor may then combine the first gain image and the second gain image to generate the first image in accordance with the DCG mode. For instance, the first gain image may be read out first, followed by the second gain image, and then combined to generate the first image.

In one or more examples, the first image generated using DCG mode may be captured with a first exposure duration. The image sensor may capture a second image with a second exposure duration that may be longer than the first exposure duration. In accordance with one or more examples, the first image, with the shorter exposure duration (e.g., first exposure duration), using DCG mode may function as the anchor image, while the second image, with the longer exposure duration (e.g., second exposure duration), may be skipped from frame time to frame time or captured at a lower resolution.

In this manner, there may not be a loss in image content or reduced resolution in image content of the anchor image, which may in turn minimize artifacts when generating the HDR image. For instance, the camera processor may at least one of store (e.g., in one or more memories) the second image for generating a first HDR image and to reuse for generating a second HDR image, or upscale the second image to generate an upscaled second image for generating the first HDR image. By reusing the second image for generating a second HDR image, there may be power savings because the second image does not need to be recaptured. Also, there may be power saving gains by capturing the second image at lower resolution and upscaling for generating the first HDR image.

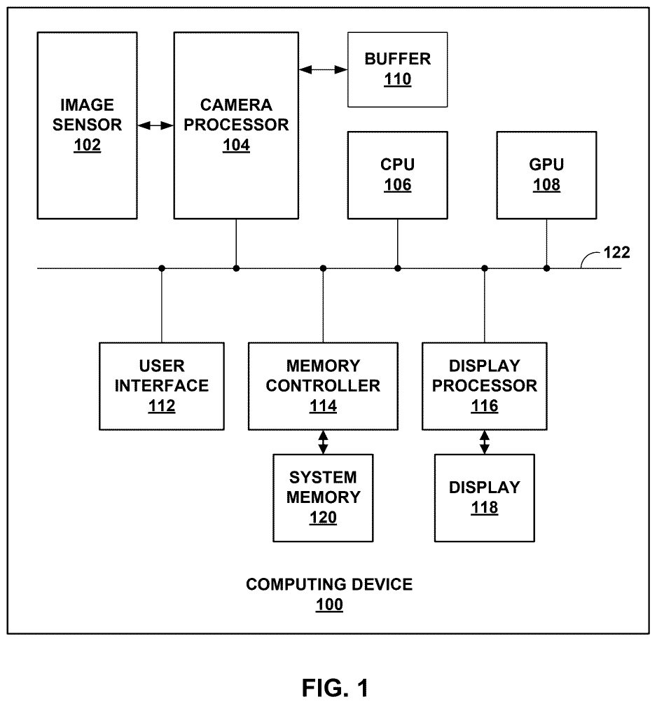

FIG. 1 is a block diagram of a device configured to perform one or more of the example techniques described in this disclosure. Examples of computing device 100 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), a landline telephone for teleconferencing, an Internet telephone, a handheld device such as a portable video game device or a personal digital assistant (PDA). Additional examples of computing device 100 include a personal music player, a video player, a display device, a camera, a television, a set-top box, a broadcast receiver device, a server, an intermediate network device, a mainframe computer or any other type of device that processes and/or displays graphical data.

As illustrated in the example of FIG. 1, computing device 100 includes image sensor 102, a camera processor 104, a central processing unit (CPU) 106, a graphical processing unit (GPU) 108, user interface 112, memory controller 114 that provides access to system memory 120, and display processor 116 that outputs signals that cause graphical data to be displayed on display 118. In FIG. 1, camera processor 104 is coupled to buffer 110. In one or more examples, buffer 110 may be dedicated buffer memory for camera processor 104. That is, buffer 110 may not be available to other components for storage. In some examples, buffer 110 may not be needed, and may be part of system memory 120.

In some examples, buffer 110 may be part of camera processor 104, and may be dedicated memory of camera processor 104. In some examples, buffer 110, when located within camera processor 104, may be dedicated for storing one or more images.

Although FIG. 1 illustrates image sensor 102 as part of the same device that includes camera processor 104, CPU 106, and GPU 108, the techniques described in this disclosure are not so limited. In some examples, camera processor 104, CPU 106, and GPU 108 and many of the various other components illustrated in FIG. 1 may be on a different device (e.g., a processing device) than image sensor 102.

Also, although the various components are illustrated as separate components, in some examples the components may be combined to form a system on chip (SoC). As an example, camera processor 104, CPU 106, GPU 108, and display processor 116 may be formed on a common integrated circuit (IC) chip. In some examples, one or more of camera processor 104, CPU 106, GPU 108, and display processor 116 may be in separate IC chips. Various other permutations and combinations are possible, and the techniques should not be considered limited to the example illustrated in FIG. 1. The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

The various units illustrated in FIG. 1 communicate with each other using bus 122. Bus 122 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 1 is merely exemplary, and other configurations of computing devices and/or other image processing systems with the same or different components may be used to implement the techniques of this disclosure.

Camera processor 104 may be external to computing device 100; however, it may be possible for camera processor 104 to be internal to computing device 100, as illustrated. For instance, in some examples, image sensor 102 and camera processor 104 may form a pluggable camera for a desktop or laptop computer, and CPU 106, GPU 108, and the various other components may be part of the desktop or laptop computer. For ease of description, the examples are described with respect to the configuration illustrated in FIG. 1.

Image sensor 102 includes a plurality of sensor elements (e.g., photodiodes) arranged in 2×2 grid, as one non-limiting example. The sensor elements may be CMOS (Complementary Metal-Oxide-Semiconductor) sensor elements. Each sensor element generates an electrical signal based on a luminance of the light incident to the sensor element. With filtering, such as Bayer filtering, the electrical signals generated by each of the sensor element indicate the luminance of a particular color.

For instance, the output from image sensor 102 may be samples associated with different colors (e.g., red, green, blue samples). Based on the particular filtering that is used, each of the colors may be sub-sampled relative to the number of sensor elements.

Camera processor 104 is configured to receive electrical signals as sensor signals from respective sensor elements of image sensor 102 and process the electrical signals to generate pixel data of an image. As one example, camera processor 104 may upsample the red color samples to generate red samples of a red color frame, upsample the green color samples to generate green color samples of a green color frame, and upsample the blue color samples to generate blue color samples of a blue color frame. The upsampling may be optional, but for purposes of illustration only the examples are described with respect to a plurality of color frames (e.g., red, green, and blue color frames) having the same resolution as an image. In examples where upsampling is not performed, there may be other techniques to address the difference in resolution between the image and the color frames.

The pixels of the image may be a combination of the samples from each of the color frames. For instance, the top-left pixel of the image may be a combination of the top-left samples of the red color frame, the green color frame, and blue color frame, the pixel immediately to the right of the top-left pixel of the image may be a combination of the samples immediately to the right of the top-left samples of the red color frame, the green color frame, and the blue color frame, and so forth. Accordingly, the pixels of the image are based on color values of samples in each color frame of a plurality of color frames of the image, where each color frame is associated with a different color.

In some examples, camera processor 104 may be configured as a single-input-multiple-data (SIMD) architecture. Camera processor 104 may perform the same operations on electrical signals received from each of the sensor elements of image sensor 102. Each lane of the SIMD architecture may include an image pipeline. The image pipeline includes hardwire circuitry and/or programmable circuitry (e.g., at least one of fixed-function or programmable circuitry) to process the output of the sensors to generate pixel values for pixels.

In one or more examples, processing circuitry of image sensor 102 may include respective trans-impedance amplifiers (TIAs) to convert the electrical signals (e.g., current) to a voltage and respective analog-to-digital converters (ADCs) that convert the analog voltage output into a digital value. The electrical signal outputted by each sensor element indicates the luminance (e.g., light intensity) of a red, green, or blue component. These examples described with respect to processing circuitry of image sensor 102 may be part of camera processor 104, in some examples.

Camera processor 104 may also perform noise reduction and image sharpening, as additional examples. Camera processor 104 outputs the resulting images (e.g., pixel values for each of the image pixels) to system memory 120 via memory controller 114.

CPU 106 may comprise a general-purpose or a special-purpose processor that controls operation of computing device 100. A user may provide input to computing device 100 to cause CPU 106 to execute one or more software applications. The user may provide input to computing device 100 via one or more input devices (not shown) such as a keyboard, a mouse, a microphone, a touch pad or another input device that is coupled to computing device 100 via user interface 112.

One example of the software application is a camera application. CPU 106 executes the camera application, and in response, the camera application causes CPU 106 to generate content that display 118 outputs. For instance, display 118 may output information such as light intensity, whether flash is enabled, and other such information. The user of computing device 100 may interface with display 118 to configure the manner in which the images are generated (e.g., with or without flash, focus settings, exposure settings, and other parameters). The camera application also causes CPU 106 to instruct camera processor 104 to process the images captured by image sensor 102 in the user-defined manner.

GPU 108 may generate graphical information that provides the user information about the image frames to be captured. For instance, GPU 108 may generate a graphic that indicates whether flash is enabled, generate boxes around identified faces, etc.

Memory controller 114 facilitates the transfer of data going into and out of system memory 120. For example, memory controller 114 may receive memory read and write commands, and service such commands with respect to memory 120 in order to provide memory services for the components in computing device 100. Memory controller 114 is communicatively coupled to system memory 120. Although memory controller 114 is illustrated in the example of computing device 100 of FIG. 1 as being a processing circuit that is separate from both CPU 106 and system memory 120, in other examples, some or all of the functionality of memory controller 114 may be implemented on one or both of CPU 106 and system memory 120.

System memory 120 may store program modules and/or instructions and/or data that are accessible by camera processor 104, CPU 106, and GPU 108. For example, system memory 120 may store user applications (e.g., instructions for the camera application), resulting images from camera processor 104, etc. System memory 120 may additionally store information for use by and/or generated by other components of computing device 100. For example, system memory 120 may act as a device memory for camera processor 104. System memory 120 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 120 may include instructions that cause camera processor 104, CPU 106, GPU 108, and display processor 116 to perform the functions ascribed to these components in this disclosure. Accordingly, system memory 120 may be a computer-readable storage medium having instructions stored thereon that, when executed, cause one or more processors (e.g., camera processor 104, CPU 106, GPU 108, and display processor 116) to perform various functions.

In some examples, system memory 120 is a non-transitory storage medium. The term “non-transitory” indicates that the storage medium is not embodied in a carrier wave or a propagated signal. However, the term “non-transitory” should not be interpreted to mean that system memory 120 is non-movable or that its contents are static. As one example, system memory 120 may be removed from computing device 100, and moved to another device. As another example, memory, substantially similar to system memory 120, may be inserted into computing device 100. In certain examples, a non-transitory storage medium may store data that can, over time, change (e.g., in RAM).

Camera processor 104, CPU 106, and GPU 108 may store image data, and the like in respective buffers that are allocated within system memory 120. Display processor 116 may retrieve the data from system memory 120 and configure display 118 to display the image represented by the generated image data. In some examples, display processor 116 may include a digital-to-analog converter (DAC) that is configured to convert the digital values retrieved from system memory 120 into an analog signal consumable by display 118. In other examples, display processor 116 may pass the digital values directly to display 118 for processing.

Display 118 may include a monitor, a television, a projection device, a liquid crystal display (LCD), a plasma display panel, a light emitting diode (LED) array, or another type of display unit. Display 118 may be integrated within computing device 100. For instance, display 118 may be a screen of a mobile telephone handset or a tablet computer. Alternatively, display 118 may be a stand-alone device coupled to computing device 100 via a wired or wireless communications link. For instance, display 118 may be a computer monitor or flat panel display connected to a personal computer via a cable or wireless link.

Camera processor 104 may be configured to generate a high dynamic range (HDR) image by combining (e.g., fusing) image contents from multiple images. Image sensor 102 may be configured to generate a first image with a first exposure duration and generate a second image with a second exposure duration. The exposure duration may refer to the amount of time that image sensor 102 exposes the photodiodes to light. The first exposure duration and the second exposure duration may be different, with the first exposure duration being less than the second exposure duration. A frame time, as used in this disclosure, refers to an amount of time it takes image sensor 102 to generate (e.g., output or readout the first image and the second image) the first image and the second image, and may also include the amount of time it takes camera processor 104 to generate the HDR image.

In some cases, camera processor 104 selects the first image or the second image as an anchor image. The anchor image may serve as the primary source of image content during the fusion process of generating the HDR image. When there are discrepancies in image content between the images due to motion or other factors, the camera processor 104 prioritizes the content from the anchor image to ensure consistency and minimize visual artifacts in the final HDR image. For multiple-frame HDR fusion, it may be better to use the image captured with the shorter exposure duration (e.g., the first image having the first exposure duration) as the anchor image for a few reasons. The contents of highlight regions may only come from the first image when motion happens in the boundary of highlight and dark/mid-tone regions because using the first image with the first exposure duration (e.g., shorter exposure duration) can avoid ghost artifact. Also, if using the image captured with the longer exposure duration (e.g., the second image having the second exposure duration) as the anchor image, multiple images captured with the shorter exposure duration may be needed to avoid ghosting. However, capturing multiple images with shorter exposure duration may be difficult for preview video or real time processing.

For power savings, it may be possible to skip utilizing the first image or the second image, or capture the first image or the second image at a lower resolution. For example, for image skipping, image sensor 102 may capture a first image with the first exposure duration and a second image with the second exposure duration over a first frame time, and camera processor 104 may generate a first HDR image by fusing the first image and the second image. For a second frame time, image sensor 102 may capture a third image with the second exposure duration, and not capture an image with the first exposure duration or camera processor 104 may not utilize the image that is captured with the first exposure duration. In this example, camera processor 104 may generate a second HDR image for the second frame time by fusing the first image, from the first frame time, and the third image.

For lower resolution image capture, image sensor 102 may capture a first image with the first exposure duration and with a lower resolution relative to the second image, and capture the second image with the second exposure duration with the higher resolution relative to the first image over a first frame time. There may be various ways in which image sensor 102 may capture the first image with a lower resolution. As one example, image sensor 102 may utilize binning, where image sensor 102 combines signals from adjacent photodiodes to form a single pixel, or subsampling, where image sensor 102 samples signals from a subset of photodiodes.

Camera processor 104 may upscale the first image so that the upscaled first image and the second image have the same resolution, and generate a first HDR image, for the first frame time, by fusing the upscaled first image and the second image. For a second frame time, image sensor 102 may capture a third image with the first exposure duration and with a lower resolution relative to a fourth image, and capture the fourth image with the second exposure duration with the higher resolution relative to the third image over a second frame time. Camera processor 104 may upscale the third image so that the upscaled third image and the fourth image have the same resolution, and generate a second HDR image, for the second frame time, by fusing the upscaled third image and the fourth image.

If the images captured with the lower exposure duration (e.g., the first exposure duration) are used as the anchor images, but utilizing of the anchor images may be skipped or capturing of the anchor images may be performed at lower resolution, there may be unwanted image artifacts in the HDR images. For instance, the resulting HDR images may have worse image quality trade-off since the anchor images are only at one-half rate for image skipping (e.g., only half of the images with the lower exposure duration are available) or only quarter resolution where the anchor image is lower resolution. For the image skipping, the HDR images may appear as if captured at half-frame rate, which may negatively impact viewer experience. For using lower resolution anchor images, the HDR images may include false color in areas with high frequency colors, and obvious low resolution (e.g., fuzzy image content) in motion areas.

This disclosure describes example techniques that may provide the power saving benefit of image skipping or capturing at lower resolution, while minimizing negative impacts on the generated HDR images. For instance, in one or more examples, the first image with the first exposure duration (e.g., shorter exposure duration) is captured at each frame time, and at full resolution, and forms the anchor image. The second image with the second exposure duration (e.g., longer exposure duration) may be skipped from frame time to frame time, or may be captured at a lower resolution.

In one or more examples, image sensor 102 may generate the first image using dual conversion gain (DCG) mode with the first exposure duration. In DCG mode, image sensor 102 may generate a first gain image using a first level of gain with the first exposure duration and generate a second gain image using a second level of gain with the first exposure duration. For example, the photodiodes of image sensor 102 may couple to a first gain circuitry that applies a first gain level to the currents generated from the photodiodes to generate the first gain image. The photodiodes of image sensor 102 may couple to a second gain circuitry that applies a second gain level (e.g., lower than first gain level) to the currents generated from the photodiodes to generate the second gain image. Image sensor 102 may combine the first gain image and the second gain image to generate the first image.

In one or more examples, the DCG mode may include generating an HDR image (e.g., a DCG HDR image). With the example techniques, camera processor 104 may generate an HDR using the DCG HDR image and another image to generate another HDR image having even more dynamic range. The DCG mode generating an HDR image is one example, and in some examples, the DCG mode may not generate an HDR image.

Although image sensor 102 is described as generating the first image, the example techniques are not so limited. In some examples, camera processor 104 may combine the first gain image and the second gain image to generate the first image.

Accordingly, camera processor 104 may receive a first image generated using DCG mode with a first exposure duration, the DCG mode including combining a first gain image generated using a first level of gain and a second gain image generated using a second level of gain to generate the first image. Camera processor 104 may receive a second image generated with a second exposure duration, the second exposure duration being greater than the first exposure duration. Camera processor 104 may generate a HDR image based on at least the first image and the second image.

In one or more examples, the first image is an anchor image. To generate the HDR image, camera processor 104 may be configured to determine that a first portion of image content in the anchor image is same as a corresponding first portion of image content in the second image, and determine that a second portion of image content in the anchor image is different than a corresponding second portion of image content in the second image. For example, camera processor 104 may compare pixel values of a first pixel in the first image with a first pixel in a corresponding location (e.g., same location) in the second image (e.g., the second image itself or upscaled version of second image), compare pixel values of a second pixel in the first image with a second pixel in a corresponding location (e.g., same location) in the second image (or upscaled version of second image), and so forth. Based on the comparison, camera processor 104 may determine portions in the first image and the second image with the same image content (e.g., if the corresponding pixel values match), and portions in the first image and the second image with different image content (e.g., if the corresponding pixel values do not match).

To generate the HDR image, camera processor 104 may fuse the first portion of image content from the anchor image and the first portion of image content from second image (e.g., fuse the portions that are the same). However, camera processor 104 may utilize the second portion of the anchor image to generate the HDR image. As one example, camera processor 104 may copy the image content of the second portion in the first image (e.g., anchor image) into the corresponding location within the HDR image to generate the image content for the HDR image. In this manner, camera processor 104 may prioritize the image content from the anchor image (e.g., first image).

As described above, in some examples, for power saving, image sensor 102 may skip capturing an image with the second exposure duration or camera processor 104 may not utilize the image with the second exposure duration for generating an HDR image. For instance, in the above example, the HDR image may be a first HDR image, and the first image and the second image are captured over a first frame time (e.g., generated, output, or readout over a frame time). Camera processor 104 may receive a third image generated using the DCG mode with the first exposure duration, where the third image is captured over a second frame time (e.g., generated, output, or readout over a frame time) after the first frame time. In this example, camera processor 104 may generate a second HDR image based on at least the third image and the second image. The third image may be the anchor image in this example for generating the second HDR image.

As another example, for power saving, image sensor 102 may capture an image with the second exposure duration with lower resolution. For example, a resolution of the second image is less than a resolution of the first image. In this example, camera processor 104 may be configured to upscale the second image to an upscaled second image having a same resolution as the first image. To generate the HDR image, camera processor 104 may be configured to generate the HDR image based on at least the first image and the upscaled second image. The first image may be the anchor image in this example for generating the HDR image.

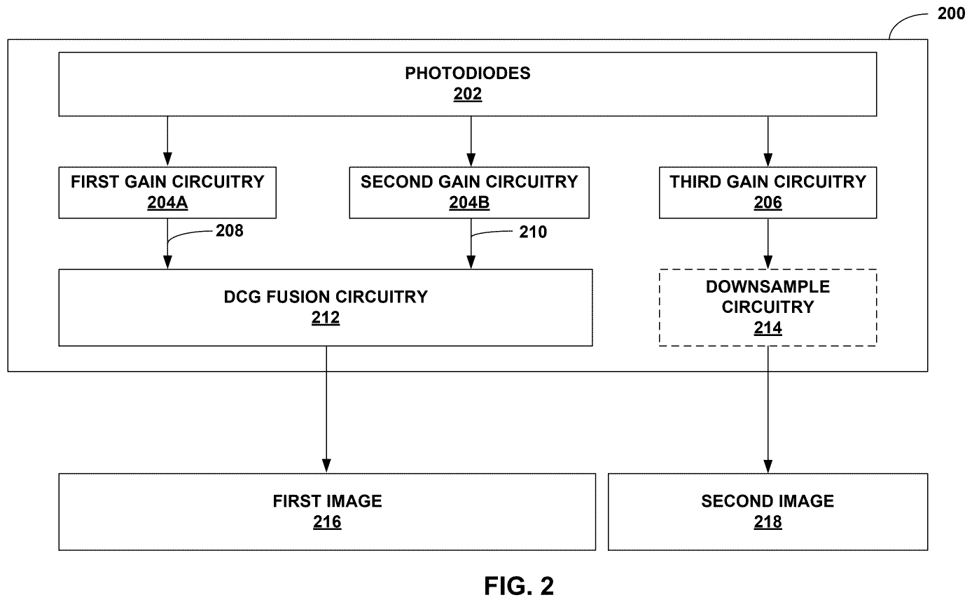

FIG. 2 is a block diagram illustrating an example image sensor configured to perform one or more of the example techniques described in this disclosure. The image sensor 200, as illustrated in FIG. 2, includes several components designed to generate images using dual conversion gain (DCG) based on different gain levels. The image sensor 200 comprises photodiodes 202, first gain circuitry 204A, second gain circuitry 206B, third gain circuitry 206, DCG fusion circuitry 212, and downsample circuitry 214 (optional). The image sensor 200 generates a first image 216 and a second image 218, which are utilized in the generation of high dynamic range (HDR) images.

In one or more examples, first gain circuitry 204A, second gain circuitry 206B, and third gain circuitry 206 may share common circuit elements but are illustrated separately for ease. In one or more examples, one or more of first gain circuitry 204A, second gain circuitry 206B, and third gain circuitry 206 may be separate circuitry.

The photodiodes 202 are responsible for converting incident light into electrical signals. These photodiodes 202 are typically arranged in a grid pattern and can be implemented using complementary metal-oxide-semiconductor (CMOS) technology. Each photodiode 202 generates an electrical signal proportional to the luminance of the light incident upon the photodiode 202. The electrical signals from the photodiodes 202 serve as the raw data for subsequent image processing stages.

The first gain circuitry 204A amplifies the electrical signals, providing a first level of gain, from photodiodes 202. The output of first gain circuitry 204A may be first gain image 208. First gain image 208 may be captured at a first exposure duration (e.g., the shorter exposure duration from among the images used for generating an HDR image).

The second gain circuitry 204B amplifies the electrical signals, providing a second level of gain, from photodiodes 202. The output of second gain circuitry 204B may be second gain image 210. Like first gain image 208, second gain image 210 may be captured at the first exposure duration (e.g., the shorter exposure duration from among the images used for generating an HDR image).

In one or more examples, the first level of gain may be a higher than the second level of gain. Accordingly, first gain image 208 may be referred to as HCG (high conversion gain) image 208, and second gain image 210 may be referred to as LCG (low conversion gain) image 210. In one or more examples, DCG fusion circuitry 212 may readout first gain image 208 (e.g., the HCG image) first, followed by second gain image 210 (e.g., the LCG image). First gain circuitry 204A and first gain image 208 may be used to enhance the visibility of darker regions, and second gain circuitry 204B and second gain image 210 may be used to cover brighter regions where first gain image 208 may saturate.

DCG fusion circuitry 212 may receive the first gain image 208 and the second gain image 210 and combine the first gain image 208 and the second gain image 210 to generate first image 216. For example, DCG fusion circuitry 212 may perform an average, weighted average, or some other blending technique to fuse pixels from the first gain image 208 and the second gain image 210 to generate first image 216. Although DCG fusion circuitry 212 is illustrated as part of image sensor 200, in some examples, camera processor 104 may include DCG fusion circuitry 212. Also, it may be possible for first gain circuitry 204A or second gain circuitry 204B to be part of camera processor 104.

Third gain circuitry 206 may be configured to amplify the electrical signals, providing a third level of gain, from photodiodes 202 to a level suitable for further processing. In some examples, third gain circuitry 206 may be configured to provide the same level of gain as the first gain circuitry (e.g., third level of gain and first level of gain are the same). In such examples, third gain circuitry 206 may not be separate circuitry, and first gain circuitry 204A can be leveraged. The output of third gain circuitry 206 may be second image 218. Second image 218 may be captured at a second exposure duration (e.g., the longer exposure duration from among the images used for generating an HDR image). Accordingly, second image 218 may be based on the higher gain level (e.g., first gain level of first gain circuitry 204A), but may be captured at a longer exposure duration (e.g., second exposure duration) than first image 216.

In some examples, image sensor 200 may include downsample circuitry 214. Downsample circuitry 214 may receive the output from third gain circuitry 206 and downsample (e.g., binning or some other downsampling technique) to generate second image 218 having a lower resolution than first image 216. Although illustrated as receiving the output from third gain circuitry 206, downsample circuitry 214 may receive the output from photodiodes 202 or some other intermediate circuitry, perform downsampling, and then output to third gain circuitry 206 to generate second image 218 having the lower resolution. For instance, downsample circuitry 214 may perform the binning or subsampling of photodiodes 202, and then output to third gain circuitry 206 to generate second image 218. In some examples, third gain circuitry 206 and optional downsample circuitry 214 may be part of camera processor 104 instead of image sensor 200, or may be split between camera processor 104 and image sensor 200.

Image sensor 200 or camera processor 104 may generate first image 216 and second image 218 within a frame time. Generating first image 216 and second image 218 within a frame time may mean that the first image 216 and the second image 218 are output or readout within the frame time. The frame time may be a function of the display frame rate (e.g., frames per second (fps)), and may be represented as 1/fps.

First image 216, generated using DCG mode and shorter exposure duration, may be the anchor image, and second image 218 may be generated using longer exposure duration. In examples where image skipping is used for power saving, the generation or usage of second image 218 may skipped frame time to frame time, and downsample circuitry 214 may not be needed. In examples where lower resolution is used for power saving, downsample circuitry 214 may be used to generate a lower resolution second image 218. In some examples, it may be possible to use both the image skipping and lower resolution for power saving.

In one or more examples, image sensor 200 or camera processor 104 may generate (e.g., output or readout) first image 216 and second image 218 one after the other but within the frame time. For example, image sensor 200 may open a shutter over photodiodes 202 for a first exposure duration to generate first image 216, close the shutter, and then open the shutter for a second exposure duration to generate second image 218. As another example, image sensor 200 may open a shutter over photodiodes 202 for a first exposure duration, generate first image 216, and then wait for an additional amount of time until reaching the second exposure duration to generate second image 218. Once generated, the amount of time to output or readout first image 216 and second image 218 may be less than or equal to the frame time. There may be various ways in which to generate first image 216 and second image 218 within the frame time, and the example techniques are not limited to any particular example.

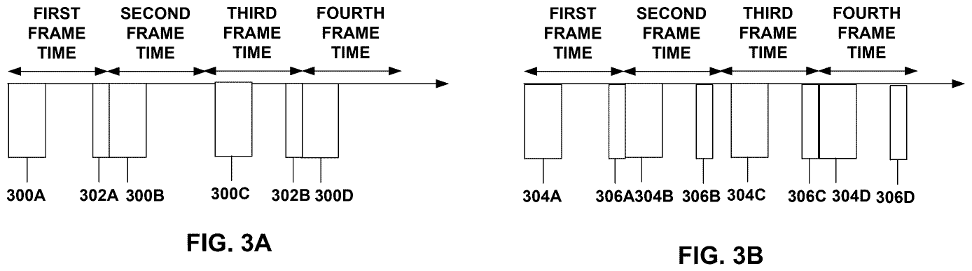

FIGS. 3A and 3B are conceptual diagrams illustrating examples of frame times and exposure durations of images captured during the frame times. For ease, FIGS. 3A and 3B are described with respect to image sensor 200 and camera processor 104.

FIG. 3A illustrates an example of image skipping for power saving in generating an HDR image. For instance, over a first frame time, image sensor 200 or camera processor 104 may generate first image 300A using DCG mode with a first exposure duration (e.g., short exposure duration) and generate second image 302A with high gain (e.g., from third gain circuitry 206) with a second exposure duration (e.g., long exposure duration). Camera processor 104 may generate a first HDR image using first image 300A and second image 302A (e.g., using fusion). In some examples, first image 300A may be readout first followed by second image 302A, which may result in reduced motion artifacts. However, second image 302A may be readout first followed by first image 300A in other examples. Also, although first image 300A is generated with short exposure duration, the amount of time needed to read out first image 300A may be greater than the amount of time needed to read out second image 302A, as illustrated, but the techniques are not so limited.

Over a second frame time, image sensor 200 or camera processor 104 may generate third image 300B using DCG mode with the first exposure duration. In this example, image sensor 200 or camera processor 104 may not generate a long exposure duration image or even if generated may not be used for generating the second HDR image. Camera processor 104 may generate a second HDR image using third image 300B and second image 302A (e.g., reuse second image 302A). In this example, camera processor 104 may store second image 302A in one or more memories so that second image 302A is available for reuse.

Over a third frame time, image sensor 200 or camera processor 104 may generate fourth image 300C using DCG mode with the first exposure duration (e.g., short exposure duration) and generate fifth image 302B with high gain (e.g., from third gain circuitry 206) with the second exposure duration (e.g., long exposure duration). Camera processor 104 may generate a third HDR image using fourth image 300C and fifth image 302B (e.g., using fusion). In some examples, fourth image 300C may be readout first followed by fifth image 302B, which may result in reduced motion artifacts. However, fifth image 302B may be readout first followed by fourth image 300C in other examples. Also, although fourth image 300C is generated with short exposure duration, the amount of time needed to read out fourth image 300C may be greater than the amount of time needed to read out fifth image 302B, as illustrated, but the techniques are not so limited.

Over a fourth frame time, image sensor 200 or camera processor 104 may generate sixth image 300D using DCG mode with the first exposure duration. In this example, image sensor 200 or camera processor 104 may not generate a long exposure duration image or even if generated may not be used for generating the fourth HDR image. Camera processor 104 may generate a fourth HDR image using sixth image 300D and fifth image 302B (e.g., reuse fifth image 302B). In this example, camera processor 104 may store fifth image 302B in one or more memories so that fifth image 302B is available for reuse.

To generate first image 300A, third image 300B, fourth image 300C, and sixth image 300D, image sensor 200 may generate a respective first gain image (e.g., over a first exposure duration) generated using a first level of gain (e.g., from first gain circuitry 204A) and generate a respective second gain image (e.g., over the first exposure duration) generated using a second level of gain (e.g., from second gain circuitry 204B). Image sensor 200 or camera processor 104 may combine the respective first gain images and the respective second gain images to generate the respective ones of first image 300A, third image 300B, fourth image 300C, and sixth image 300D. To generate second image 302A and fifth image 302B, image sensor 200 or camera processor 104 may apply a third level of gain (e.g., from third gain circuitry 206) with the second exposure duration.

FIG. 3B illustrates an example of lower resolution image processing for power saving in generating an HDR image. For instance, over a first frame time, image sensor 200 or camera processor 104 may generate first image 304A using DCG mode with a first exposure duration (e.g., short exposure duration). Image sensor 200 may generate second image 306A with high gain (e.g., from third gain circuitry 206) with a second exposure duration (e.g., long exposure duration). In this example, image sensor 200 or camera processor 104 may utilize some downsampling techniques (e.g., binning from downsample circuitry 214) to generate second image 306A. A resolution of second image 306A may be less than (e.g., a quarter of) a resolution of first image 304A. Camera processor 104 may generate a first HDR image using first image 304A and second image 306A (e.g., using fusion after upsampling second image 306A).

Similar to above, in some examples, first image 304A may be readout first followed by second image 306A, which may result in reduced motion artifacts. However, first image 304A may be readout first followed by second image 306A in other examples. Also, although first image 304A is generated with short exposure duration, the amount of time needed to read out first image 304A may be greater than the amount of time needed to read out second image 306A, as illustrated, but the techniques are not so limited.

Over a second frame time, image sensor 200 or camera processor 104 may generate third image 304B using DCG mode with a first exposure duration (e.g., short exposure duration). Image sensor 200 may generate fourth image 306B with high gain (e.g., from third gain circuitry 206) with a second exposure duration (e.g., long exposure duration). In this example, image sensor 200 or camera processor 104 may utilize some downsampling techniques (e.g., binning from downsample circuitry 214) to generate fourth image 306B. A resolution of fourth image 306B may be less than (e.g., a quarter) of a resolution of third image 304B. Camera processor 104 may generate a second HDR image using third image 304B and fourth image 306B (e.g., using fusion after upsampling fourth image 306B).

Similar to above, in some examples, third image 304B may be readout first followed by fourth image 306B, which may result in reduced motion artifacts. However, third image 304B may be readout first followed by fourth image 306B in other examples. Also, although third image 304B is generated with short exposure duration, the amount of time needed to read out third image 304B may be greater than the amount of time needed to read out fourth image 306B, as illustrated, but the techniques are not so limited.

Over a third frame time, image sensor 200 or camera processor 104 may generate fifth image 304C using DCG mode with a first exposure duration (e.g., short exposure duration). Image sensor 200 may generate sixth image 306C with high gain (e.g., from third gain circuitry 206) with a second exposure duration (e.g., long exposure duration). In this example, image sensor 200 or camera processor 104 may utilize some downsampling techniques (e.g., binning from downsample circuitry 214) to generate sixth image 306C. A resolution of sixth image 306C may be less than (e.g., a quarter) of a resolution of fifth image 304C. Camera processor 104 may generate a third HDR image using fifth image 304C and sixth image 306C (e.g., using fusion after upsampling sixth image 306C).

Similar to above, in some examples, fifth image 304C may be readout first followed by sixth image 306C, which may result in reduced motion artifacts. However, fifth image 304C may be readout first followed by sixth image 306C in other examples. Also, although fifth image 304C is generated with short exposure duration, the amount of time needed to read out fifth image 304C may be greater than the amount of time needed to read out sixth image 306C, as illustrated, but the techniques are not so limited.

Over a fourth frame time, image sensor 200 or camera processor 104 may generate seventh image 304D using DCG mode with a first exposure duration (e.g., short exposure duration). Image sensor 200 may generate eight image 306D with high gain (e.g., from third gain circuitry 206) with a second exposure duration (e.g., long exposure duration). In this example, image sensor 200 or camera processor 104 may utilize some downsampling techniques (e.g., binning from downsample circuitry 214) to generate eighth image 306D. A resolution of eighth image 306D may be less than (e.g., a quarter) of a resolution of seventh image 304D. Camera processor 104 may generate a fourth HDR image using seventh image 304D and eighth image 306D (e.g., using fusion after upsampling eighth image 306D).

Similar to above, in some examples, seventh image 304D may be readout first followed by eighth image 306D, which may result in reduced motion artifacts. However, seventh image 304D may be readout first followed by eighth image 306D in other examples. Also, although seventh image 304D is generated with short exposure duration, the amount of time needed to read out seventh image 304D may be greater than the amount of time needed to read out eighth image 306D, as illustrated, but the techniques are not so limited.

To generate first image 304A, third image 304B, fifth image 304C, and seventh image 304D, image sensor 200 may generate a respective first gain image (e.g., over a first exposure duration) generated using a first level of gain (e.g., from first gain circuitry 204A) and generate a respective second gain image (e.g., over the first exposure duration) generated using a second level of gain (e.g., from second gain circuitry 204B). Image sensor 200 or camera processor 104 may combine the respective first gain images and the respective second gain images to generate the respective ones of first image 304A, third image 304B, fifth image 304C, and seventh image 304D.

To generate second image 306A, fourth image 306B, sixth image 306C, and eighth image 306D, image sensor 200 or camera processor 104 may apply a third level of gain (e.g., from third gain circuitry 206) with the second exposure duration. Downsample circuitry 214 may downsample (e.g., binning) the output from third gain circuitry 206 to generate respective ones of second image 306A, fourth image 306B, sixth image 306C, and eighth image 306D. Other techniques such as subsampling or other downsampling techniques may used to generate second image 306A, fourth image 306B, sixth image 306C, and eighth image 306D. In general, a resolution of each of second image 306A, fourth image 306B, sixth image 306C, and eighth image 306D may be lower than a resolution of each of first image 304A, third image 304B, fifth image 304C, and seventh image 304D, where first image 304A and second image 306A are used to generate the first HDR image, third image 304B and fourth image 306B are used to generate the second HDR image, fifth image 304C and sixth image 306C are used to generate the third HDR image, and seventh image 304D and eighth image 306D are used to generate the fourth HDR image.

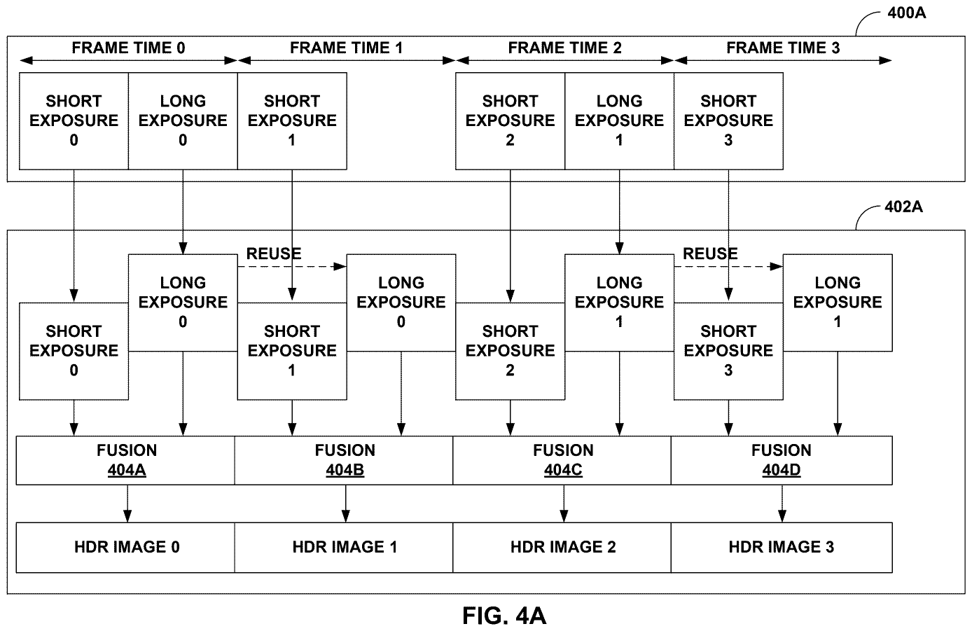

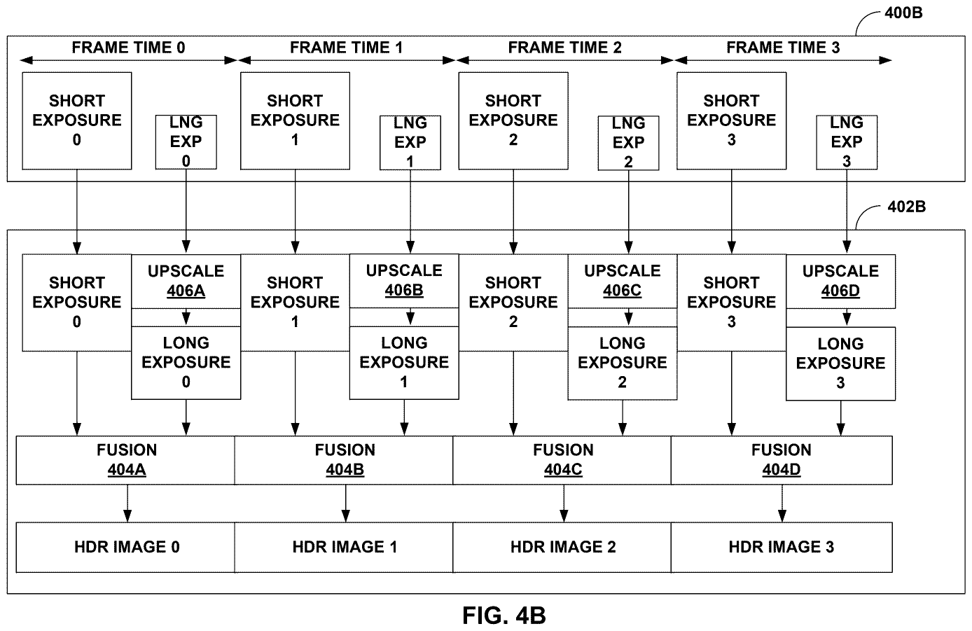

FIGS. 4A and 4B are conceptual diagrams illustrating examples fusion of different images for generating high dynamic range (HDR) images. FIGS. 4A and 4B include image sensor 400A and 400B, respectively, which may be similar or same as image sensor 102 or image sensor 200. FIGS. 4A and 4B include camera processor 402A and 402B, which may be similar or same as camera processor 104. Also, the separation of components and processes between image sensor 400A and camera processor 402A or image sensor 400B and camera processor 402B is provided as one example, and should not be considered limiting.

FIG. 4A illustrates an example of using image skipping for power saving. In FIG. 4A, over frame time 0, image sensor 400A may generate long exposure image 0 (e.g., captured over a second, longer exposure duration) and short exposure image 0 (e.g., captured over a first, shorter exposure duration). Also, image sensor 400A may generate short exposure image 0 using DCG mode.

Camera processor 402A may receive long exposure image 0 and short exposure image 0, and perform fusion operation 404A to generate HDR image 0. Short exposure image 0 may be an anchor image. To generate the HDR image 0, camera processor 402A may be configured to determine that a first portion of image content in the anchor image (e.g., short exposure image 0) is same as a corresponding first portion of image content in the second image (e.g., long exposure image 0). Camera processor 402A may determine that a second portion of image content in the anchor image (e.g., short exposure image 0) is different than a corresponding second portion of image content in the second image (e.g., long exposure image 0). Camera processor 402A may fuse (e.g., with fusion operation 404A), the first portion of image content from the anchor image (e.g., short exposure image 0) and the first portion of image content from second image (e.g., long exposure image 0) and utilize the second portion of the anchor image (e.g., short exposure image 0) to generate HDR image 0.

Over frame time 1, image sensor 400A may generate short exposure image 1 (e.g., captured over a first, shorter exposure duration). Also, image sensor 400A may generate short exposure image 1 using DCG mode. Image sensor 400A may not generate a long exposure image in frame time 1, or may generate a long exposure image in frame time 1 that is not used for generating an HDR image.

Camera processor 402A may receive short exposure image 1 and reuse long exposure image 0 (e.g., the long exposure image used previously for generating HDR image 0 and stored for reusing), and perform fusion operation 404B to generate HDR image 1. Short exposure image 1 may be an anchor image. To generate the HDR image 1, camera processor 402A may be configured to determine that a first portion of image content in the anchor image (e.g., short exposure image 1) is same as a corresponding first portion of image content in the second image (e.g., long exposure image 0). Camera processor 402A may determine that a second portion of image content in the anchor image (e.g., short exposure image 1) is different than a corresponding second portion of image content in the second image (e.g., long exposure image 0). Camera processor 402A may fuse (e.g., with fusion operation 404B), the first portion of image content from the anchor image (e.g., short exposure image 1) and the first portion of image content from second image (e.g., long exposure image 0) and utilize the second portion of the anchor image (e.g., short exposure image 1) to generate HDR image 1.

Over frame time 2, image sensor 400A may generate long exposure image 1 (e.g., captured over a second, longer exposure duration) and short exposure image 2 (e.g., captured over a first, shorter exposure duration). Also, image sensor 400A may generate short exposure image 2 using DCG mode.

Camera processor 402A may receive long exposure image 1 and short exposure image 2, and perform fusion operation 404C to generate HDR image 2. Short exposure image 2 may be an anchor image. To generate the HDR image 2, camera processor 402A may be configured to determine that a first portion of image content in the anchor image (e.g., short exposure image 2) is same as a corresponding first portion of image content in the second image (e.g., long exposure image 1). Camera processor 402A may determine that a second portion of image content in the anchor image (e.g., short exposure image 2) is different than a corresponding second portion of image content in the second image (e.g., long exposure image 1). Camera processor 402A may fuse (e.g., with fusion operation 404C), the first portion of image content from the anchor image (e.g., short exposure image 2) and the first portion of image content from second image (e.g., long exposure image 1) and utilize the second portion of the anchor image (e.g., short exposure image 2) to generate HDR image 2.

Over frame time 3, image sensor 400A may generate short exposure image 3 (e.g., captured over a first, shorter exposure duration). Also, image sensor 400A may generate short exposure image 3 using DCG mode. Image sensor 400A may not generate a long exposure image in frame time 3, or may generate a long exposure image in frame time 3 that is not used for generating an HDR image.

Camera processor 402A may receive short exposure image 3 and reuse long exposure image 1 (e.g., the long exposure image used previously for generating HDR image 2 and stored for reusing), and perform fusion operation 404B to generate HDR image 3. Short exposure image 3 may be an anchor image. To generate the HDR image 3, camera processor 402A may be configured to determine that a first portion of image content in the anchor image (e.g., short exposure image 3) is same as a corresponding first portion of image content in the second image (e.g., long exposure image 1). Camera processor 402A may determine that a second portion of image content in the anchor image (e.g., short exposure image 3) is different than a corresponding second portion of image content in the second image (e.g., long exposure image 1). Camera processor 402A may fuse (e.g., with fusion operation 404D), the first portion of image content from the anchor image (e.g., short exposure image 3) and the first portion of image content from second image (e.g., long exposure image 1) and utilize the second portion of the anchor image (e.g., short exposure image 3) to generate HDR image 3.

With the example techniques illustrated in FIG. 4A, the frame rate may be consistent and has same frame rate for motion area. That is, because the DCG mode image is used as the anchor image and has the shorter exposure duration, if there is motion between anchor image and image captured with longer exposure duration, there may not be visible artifacts.

FIG. 4B illustrates an example of using lower resolution images for power saving. In FIG. 4B, over frame time 0, image sensor 400B may generate long exposure image 0 (e.g., captured over a second, longer exposure duration) and short exposure image 0 (e.g., captured over a first, shorter exposure duration). Also, image sensor 400B may generate short exposure image 0 using DCG mode. Image sensor 400B may generate long exposure image 0 with lower resolution than short exposure image 0.

Camera processor 402B may receive long exposure image 0 and short exposure image 0. Camera processor 402B may perform upscale operation 406A on long exposure image 0 to generate upscaled long exposure image 0. Camera processor 402B may perform fusion operation 404A to generate HDR image 0. Short exposure image 0 may be an anchor image. To generate the HDR image 0, camera processor 402B may be configured to determine that a first portion of image content in the anchor image (e.g., short exposure image 0) is same as a corresponding first portion of image content in the second image (e.g., upscaled long exposure image 0). Camera processor 402B may determine that a second portion of image content in the anchor image (e.g., short exposure image 0) is different than a corresponding second portion of image content in the second image (e.g., upscaled long exposure image 0). Camera processor 402B may fuse (e.g., with fusion operation 404A), the first portion of image content from the anchor image (e.g., short exposure image 0) and the first portion of image content from second image (e.g., upscaled long exposure image 0) and utilize the second portion of the anchor image (e.g., short exposure image 0) to generate HDR image 0.

Over frame time 1, image sensor 400B may generate long exposure image 1 (e.g., captured over a second, longer exposure duration) and short exposure image 1 (e.g., captured over a first, shorter exposure duration). Also, image sensor 400B may generate short exposure image 1 using DCG mode. Image sensor 400B may generate long exposure image 1 with lower resolution than short exposure image 1.

Camera processor 402B may receive long exposure image 1 and short exposure image 1. Camera processor 402B may perform upscale operation 406B on long exposure image 1 to generate upscaled long exposure image 1. Camera processor 402B may perform fusion operation 404B to generate HDR image 1. Short exposure image 1 may be an anchor image. To generate the HDR image 1, camera processor 402B may be configured to determine that a first portion of image content in the anchor image (e.g., short exposure image 1) is same as a corresponding first portion of image content in the second image (e.g., upscaled long exposure image 1). Camera processor 402B may determine that a second portion of image content in the anchor image (e.g., short exposure image 1) is different than a corresponding second portion of image content in the second image (e.g., upscaled long exposure image 1). Camera processor 402B may fuse (e.g., with fusion operation 404B), the first portion of image content from the anchor image (e.g., short exposure image 1) and the first portion of image content from second image (e.g., upscaled long exposure image 1) and utilize the second portion of the anchor image (e.g., short exposure image 1) to generate HDR image 1.

Over frame time 2, image sensor 400B may generate long exposure image 2 (e.g., captured over a second, longer exposure duration) and short exposure image 2 (e.g., captured over a first, shorter exposure duration). Also, image sensor 400B may generate short exposure image 2 using DCG mode. Image sensor 400B may generate long exposure image 2 with lower resolution than short exposure image 2.

Camera processor 402B may receive long exposure image 2 and short exposure image 2. Camera processor 402B may perform upscale operation 406C on long exposure image 2 to generate upscaled long exposure image 2. Camera processor 402B may perform fusion operation 404C to generate HDR image 2. Short exposure image 2 may be an anchor image. To generate the HDR image 2, camera processor 402B may be configured to determine that a first portion of image content in the anchor image (e.g., short exposure image 2) is same as a corresponding first portion of image content in the second image (e.g., upscaled long exposure image 2). Camera processor 402B may determine that a second portion of image content in the anchor image (e.g., short exposure image 2) is different than a corresponding second portion of image content in the second image (e.g., upscaled long exposure image 2). Camera processor 402B may fuse (e.g., with fusion operation 404C), the first portion of image content from the anchor image (e.g., short exposure image 2) and the first portion of image content from second image (e.g., upscaled long exposure image 2) and utilize the second portion of the anchor image (e.g., short exposure image 2) to generate HDR image 2.

Over frame time 3, image sensor 400B may generate long exposure image 3 (e.g., captured over a second, longer exposure duration) and short exposure image 3 (e.g., captured over a first, shorter exposure duration). Also, image sensor 400B may generate short exposure image 3 using DCG mode. Image sensor 400B may generate long exposure image 3 with lower resolution than short exposure image 3.

Camera processor 402B may receive long exposure image 3 and short exposure image 3. Camera processor 402B may perform upscale operation 406D on long exposure image 3 to generate upscaled long exposure image 3. Camera processor 402B may perform fusion operation 404D to generate HDR image 3. Short exposure image 3 may be an anchor image. To generate the HDR image 3, camera processor 402B may be configured to determine that a first portion of image content in the anchor image (e.g., short exposure image 3) is same as a corresponding first portion of image content in the second image (e.g., upscaled long exposure image 3). Camera processor 402B may determine that a second portion of image content in the anchor image (e.g., short exposure image 3) is different than a corresponding second portion of image content in the second image (e.g., upscaled long exposure image 3). Camera processor 402B may fuse (e.g., with fusion operation 404D), the first portion of image content from the anchor image (e.g., short exposure image 3) and the first portion of image content from second image (e.g., upscaled long exposure image 3) and utilize the second portion of the anchor image (e.g., short exposure image 3) to generate HDR image 3.

With the example techniques illustrated in FIG. 4B, in the HDR images, bright area keeps same resolution, and dark area has low resolution and higher signal-to-noise ratio (SNR). That is, because the DCG mode image is used as the anchor image and has the shorter exposure duration, the resolution of bright areas is maintained, but there may be lower resolution for darker areas. However, lower resolution in darker areas may not impact visual quality.

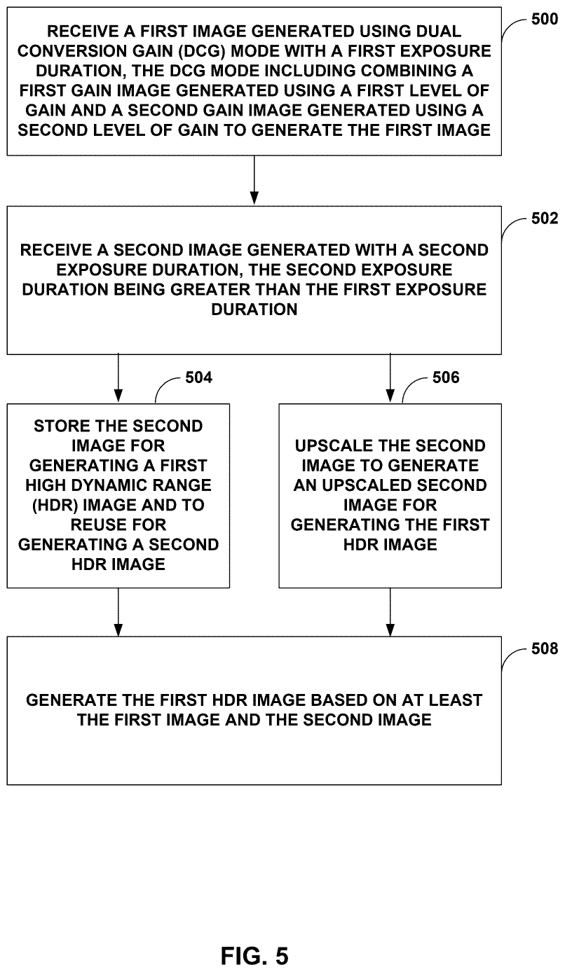

FIG. 5 is a flowchart illustrating an example method of operation. The example techniques of FIG. 5 are described with respect to processing circuitry. An example of the processing circuitry may be camera processor 104, CPU 106, GPU 108, display processor 116, or any combination thereof. For instance, computing device 100 may include one or more memories like buffer 110 or system memory 120 that store the images, such as from image sensor 102 or image sensor 200. Camera processor 104 may include processing circuitry and coupled to the one or more memories, and camera processor 104 may be configured to perform the example techniques of FIG. 5.

The processing circuitry may receive a first image generated using dual conversion gain (DCG) mode with a first exposure duration, the DCG mode including combining a first gain image generated using a first level of gain and a second gain image generated using a second level of gain to generate the first image (500). For example, image sensor 200 may generate the first gain image (e.g., first gain image 208) with the first exposure duration based on providing the first level of gain (e.g., from first gain circuitry 204A) to output of photodiodes 202 of the image sensor 200, and generate the second gain image (e.g., second gain image 210) with the first exposure duration based on providing the second level of gain (e.g., from second gain circuitry 204B) to output of the photodiodes 202 of the image sensor 200. Image sensor 200 may generate the first image (e.g., first image 216) based on the first gain image and the second gain image (e.g., by fusing with DCG fusion circuitry 212).

The processing circuitry may receive a second image generated with a second exposure duration, the second exposure duration being greater than the first exposure duration (502). For example, image sensor 200 may generate the second image (e.g., second image 218) using a third level of gain (e.g., from third gain circuitry 206). In some examples, the third level of gain (e.g., from third gain circuitry 206) is the same as the first level of gain (e.g., from first gain circuitry 204A).

The processing circuitry may, at least one of, store (e.g., in one or more memories) the second image for generating a first high dynamic range (HDR) image and to reuse for generating a second HDR image (504), or upscale the second image to generate an upscaled second image for generating the first HDR image (506). For instance, in examples where image skipping is used, the HDR image is a first HDR image, and the first image and the second image are captured over a first frame time (e.g., generated, output, or readout over a first frame time). Camera processor 104 may be configured to receive a third image generated using the DCG mode with the first exposure duration, where the third image is captured over a second frame time (e.g., generated, output, or readout over a second frame time) after the first frame time. Camera processor 104 may generate the second HDR image based on at least the third image and the second image (e.g., reuse the second image).

In some examples, such as where lower resolution images are used for power saving, a resolution of the second image is less than a resolution of the first image. In this example, camera processor 104 may be configured to upscale the second image to an upscaled second image having a same resolution as the first image. For example, image sensor 200 may generate a third gain image with the second exposure duration based on providing a third level of gain (e.g., from third gain circuitry 206) to output of photodiodes 202 of the image sensor 200, and downsample (e.g., with downsample circuitry 214) the third gain image to generate the second image.

The processing circuitry may generate an HDR image based on at least the first image and the second image (508). For instance, the first image is an anchor image. To generate the HDR image, the camera processor 104 may be configured to determine that a first portion of image content in the anchor image is same as a corresponding first portion of image content in the second image, and determine that a second portion of image content in the anchor image is different than a corresponding second portion of image content in the second image. Camera processor 104 may be configured to fuse the first portion of image content from the anchor image and the first portion of image content from second image and utilize the second portion of the anchor image to generate the HDR image. In examples where lower resolution images are used, the second image may be an upscaled second image so that the resolution of the upscaled second image and the first image is the same.

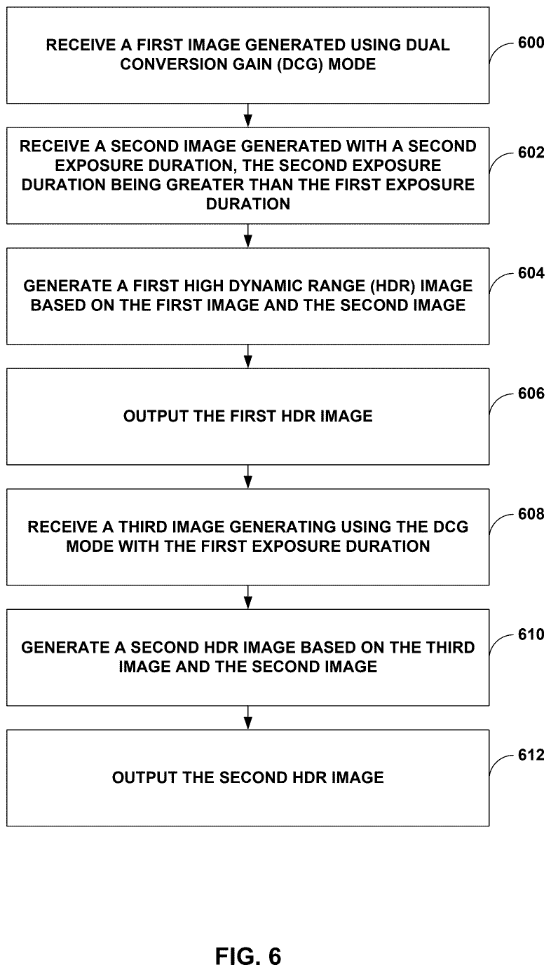

FIG. 6 is another flowchart illustrating an example method of operation. Similar to FIG. 5, the example techniques of FIG. 6 are described with respect to processing circuitry. An example of the processing circuitry may be camera processor 104, CPU 106, GPU 108, display processor 116, or any combination thereof. For instance, computing device 100 may include one or more memories like buffer 110 or system memory 120 that store the images, such as from image sensor 102 or image sensor 200. Camera processor 104 may include processing circuitry and coupled to the one or more memories, and camera processor 104 may be configured to perform the example techniques of FIG. 6.

Similar to FIG. 5, the processing circuitry may receive a first image generated using dual conversion gain (DCG) mode with a first exposure duration, the DCG mode including combining a first gain image generated using a first level of gain and a second gain image generated using a second level of gain to generate the first image (600). For example, image sensor 200 may generate the first gain image (e.g., first gain image 208) with the first exposure duration based on providing the first level of gain (e.g., from first gain circuitry 204A) to output of photodiodes 202 of the image sensor 200, and generate the second gain image (e.g., second gain image 210) with the first exposure duration based on providing the second level of gain (e.g., from second gain circuitry 204B) to output of the photodiodes 202 of the image sensor 200. Image sensor 200 may generate the first image (e.g., first image 216) based on the first gain image and the second gain image (e.g., by fusing with DCG fusion circuitry 212). One example of the first image may be first image 300A of FIG. 3A or short exposure image 0 of FIG. 4A.

The processing circuitry may receive a second image generated with a second exposure duration, the second exposure duration being greater than the first exposure duration (602). For example, image sensor 200 may generate the second image (e.g., second image 218) using a third level of gain (e.g., from third gain circuitry 206). In some examples, the third level of gain (e.g., from third gain circuitry 206) is the same as the first level of gain (e.g., from first gain circuitry 204A). One example of the second image may be second image 302A or FIG. 3A or long exposure image 0 of FIG. 4A. In some examples, to receive the second image, the processing circuitry may be configured to readout the second image after reading out the first image.

The processing circuitry may generate a first HDR image based on the first image and the second image (604). As one example, the first image is an anchor image. To generate the first HDR image, the processing circuitry may be configured to determine that a first portion of image content in the anchor image is same as a corresponding first portion of image content in the second image, determine that a second portion of image content in the anchor image is different than a corresponding second portion of image content in the second image, and fuse the first portion of image content from the anchor image and the first portion of image content from second image and utilize the second portion of the anchor image to generate the first HDR image.

The processing circuitry may output the first HDR image (606). As one example, the processing circuitry may output the first HDR image for display on display 118 as part of preview mode or as video frames are being captured and displayed. In some examples, the processing circuitry may output the first HDR image to the one or more memories for storage and for later display.

The processing circuitry may receive a third image generated using the dual DCG mode with the first exposure duration (608). One example of the third image may be third image 300B of FIG. 3A or short exposure image 1 of FIG. 4A.

The processing circuitry may generate a second HDR image based on the third image and the second image (610). For example, the third image is an anchor image. To generate the second HDR image, the processing circuitry may be configured to determine that a first portion of image content in the anchor image is same as a corresponding first portion of image content in the second image, determine that a second portion of image content in the anchor image is different than a corresponding second portion of image content in the second image, and fuse the first portion of image content from the anchor image and the first portion of image content from second image and utilize the second portion of the anchor image to generate the second HDR image.

In one or more examples, to generate the second HDR image based on the third image and the second image, the processing circuitry may be configured to access the second image from the one or more memories. For instance, as described above, the processing circuitry may store second image 302A or long exposure image 0 so that second image 302A or long exposure image 0 is available for reuse. The processing circuitry may reuse the second image (e.g., second image 302A or long exposure image 0) used for generating the first HDR image to generate the second HDR image based on the second image and the third image.

The processing circuitry may output the second HDR image (612). As one example, the processing circuitry may output the second HDR image for display on display 118 as part of preview mode or as video frames are being captured and displayed. In some examples, the processing circuitry may output the second HDR image to the one or more memories for storage and for later display.

The following describes one or more examples in accordance with the techniques described in this disclosure.

Clause 1A. A device for image processing, the device comprising: one or more memories; and a camera processor comprising processing circuitry and coupled to the one or more memories, wherein the camera processor is configured to: receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receive a second image generated with a second exposure duration, the second exposure duration being greater than the first exposure duration; at least one of: store the second image for generating a first high dynamic range (HDR) image and to reuse for generating a second HDR image; or upscale the second image to generate an upscaled second image for generating the first HDR image; and generate the first HDR image based on at least the first image and the second image or the upscaled second image.

Clause 2A. The device of clause 1A, wherein the first image is an anchor image, and wherein to generate the first HDR image, the camera processor is configured to: determine that a first portion of image content in the anchor image is same as a corresponding first portion of image content in the second image or the upscaled second image; determine that a second portion of image content in the anchor image is different than a corresponding second portion of image content in the second image or the upscaled second image; and fuse the first portion of image content from the anchor image and the first portion of image content from second image or the upscaled second image and utilize the second portion of the anchor image to generate the first HDR image.

Clause 3A. The device of any of clauses 1A and 2A, wherein the second image is generated using a third level of gain.

Clause 4A. The device of clause 3A, wherein the third level of gain is equal to the first level of gain.

Clause 5A. The device of any of clauses 1A-4A, wherein the first image and the second image are captured over a first frame time, wherein the camera processor is configured to: receive a third image generated using the DCG mode with the first exposure duration, wherein the third image is captured over a second frame time after the first frame time; and generate the second HDR image based on at least the third image and the second image.

Clause 6A. The device of any of clauses 1A-4A, wherein a resolution of the second image is less than a resolution of the first image, wherein the camera processor is configured to upscale the second image to generate the upscaled second image having a same resolution as the first image, and wherein to generate the first HDR image, the camera processor is configured to generate the first HDR image based on at least the first image and the upscaled second image.

Clause 7A. The device of any of clauses 1A-6A, further comprising an image sensor, wherein the image sensor is configured to: generate the first gain image with the first exposure duration based on providing the first level of gain to output of photodiodes of the image sensor; generate the second gain image with the first exposure duration based on providing the second level of gain to output of the photodiodes of the image sensor; and generate the first image based on the first gain image and the second gain image.

Clause 8A. The device of any of clauses 1A-7A, further comprising an image sensor, wherein the image sensor is configured to: generate a third gain image with the second exposure duration based on providing a third level of gain to output of photodiodes of the image sensor; and downsample the third gain image to generate the second image.

Clause 9A. A method of image processing, the method comprising: receiving, with a camera processor, a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receiving, with the camera processor, a second image generated with a second exposure duration, the second exposure duration being greater than the first exposure duration; at least one of: storing, with the camera processor, the second image for generating a first high dynamic range (HDR) image and to reuse for generating a second HDR image; or upscaling, with the camera processor, the second image to generate an upscaled second image for generating the first HDR image; and generating, with the camera processor, the first HDR image based on at least the first image and the second image or the upscaled second image.

Clause 10A. The method of clause 9A, wherein the first image is an anchor image, and wherein generating the first HDR image comprises: determining that a first portion of image content in the anchor image is same as a corresponding first portion of image content in the second image; determining that a second portion of image content in the anchor image is different than a corresponding second portion of image content in the second image or the upscaled second image; and fusing the first portion of image content from the anchor image and the first portion of image content from second image or the upscaled second image and utilize the second portion of the anchor image to generate the first HDR image.

Clause 11A. The method of any of clauses 9A and 10A, wherein the second image is generated using a third level of gain.

Clause 12A. The method of clause 11A, wherein the third level of gain is equal to the first level of gain.

Clause 13A. The method of any of clauses 9A-12A, wherein the first image and the second image are captured over a first frame time, the method further comprising: receiving a third image generated using the DCG mode with the first exposure duration, wherein the third image is captured over a second frame time after the first frame time; and generating the second HDR image based on at least the third image and the second image.

Clause 14A. The method of any of clauses 9A-12A, wherein a resolution of the second image is less than a resolution of the first image, wherein upscaling comprises upscaling the second image to the upscaled second image having a same resolution as the first image, and wherein generating the first HDR image comprises generating the first HDR image based on at least the first image and the upscaled second image.

Clause 15A. The method of any of clauses 9A-14A, further comprising: generating, with an image sensor, the first gain image with the first exposure duration based on providing the first level of gain to output of photodiodes of the image sensor; generating, with the image sensor, the second gain image with the first exposure duration based on providing the second level of gain to output of the photodiodes of the image sensor; and generating, with the image sensor, the first image based on the first gain image and the second gain image.

Clause 16A. The method of any of clauses 9A-15A, further comprising: generating, with an image sensor, a third gain image with the second exposure duration based on providing a third level of gain to output of photodiodes of the image sensor; and downsampling, with the image sensor, the third gain image to generate the second image.

Clause 17A. Non-transitory computer-readable storage media storing instructions thereon that when executed cause one or more processors to: receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receive a second image generated with a second exposure duration, the second exposure duration being greater than the first exposure duration; and at least one of: store the second image for generating a first high dynamic range (HDR) image and to reuse for generating a second HDR image; or upscale the second image to generate an upscaled second image for generating the first HDR image; and generate the first HDR image based on at least the first image and the second image or the upscaled second image.

Clause 18A. The non-transitory computer-readable storage media of clause 17, wherein the first image is an anchor image, and wherein the instructions that cause the one or more processors to generate the first HDR image comprise instructions that cause the one or more processors to: determine that a first portion of image content in the anchor image is same as a corresponding first portion of image content in the second image; determine that a second portion of image content in the anchor image is different than a corresponding second portion of image content in the second image or the upscaled second image; and fuse the first portion of image content from the anchor image and the first portion of image content from second image or the upscaled second image and utilize the second portion of the anchor image to generate the first HDR image.

Clause 19A. The non-transitory computer-readable storage media of any of clauses 17A and 18A, wherein the first image and the second image are captured over a first frame time, and wherein the instructions further comprise instructions that cause the one or more processors to: receive a third image generated using the DCG mode with the first exposure duration, wherein the third image is captured over a second frame time after the first frame time; and generate the second HDR image based on at least the third image and the second image.

Clause 20A. The non-transitory computer-readable storage media of any of clauses 17A and 18A, wherein a resolution of the second image is less than a resolution of the first image, wherein the instructions to upscale further comprise instructions that cause the one or more processors to upscale the second image to the upscaled second image having a same resolution as the first image, and wherein the instructions that cause the one or more processors to generate the first HDR image comprise instructions that cause the one or more processors to generate the first HDR image based on at least the first image and the upscaled second image.

Clause 1A. A device for image processing, the device comprising: one or more memories; and processing circuitry coupled to the one or more memories and configured to: receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receive a second image generated with a second exposure duration, the second exposure duration being greater than the first exposure duration; generate a first high dynamic range (HDR) image based on the first image and second image; output the first HDR image; receive a third image generated using the DCG mode with the first exposure duration; generate a second HDR image based on the third image and the second image; and output the second HDR image.

Clause 2B. The device of clause 1B, wherein the first image is an anchor image, and wherein to generate the first HDR image, the processing circuitry is configured to: determine that a first portion of image content in the anchor image is same as a corresponding first portion of image content in the second image; determine that a second portion of image content in the anchor image is different than a corresponding second portion of image content in the second image; and fuse the first portion of image content from the anchor image and the first portion of image content from second image and utilize the second portion of the anchor image to generate the first HDR image.

Clause 3B. The device of any of clauses 1B and 2B, wherein the third image is an anchor image, and wherein to generate the second HDR image, the processing circuitry is configured to: determine that a first portion of image content in the anchor image is same as a corresponding first portion of image content in the second image; determine that a second portion of image content in the anchor image is different than a corresponding second portion of image content in the second image; and fuse the first portion of image content from the anchor image and the first portion of image content from second image and utilize the second portion of the anchor image to generate the second HDR image.

Clause 4B. The device of any of clauses 1B-3B, wherein the second image is generated using a third level of gain.

Clause 5B. The device of clause 4B, wherein the third level of gain is equal to the first level of gain.

Clause 6B. The device of any of clauses 1B-5B, wherein the first image and the second image are captured over a first frame time, and wherein the third image is captured over a second frame time after the first frame time.

Clause 7B. The device of any of clauses 1B-6B, further comprising an image sensor, wherein the image sensor is configured to: generate the first gain image with the first exposure duration based on providing the first level of gain to output of photodiodes of the image sensor; generate the second gain image with the first exposure duration based on providing the second level of gain to output of the photodiodes of the image sensor; and generate the first image based on the first gain image and the second gain image.

Clause 8B. The device of any of clauses 1B-7B, wherein the processing circuitry is further configured to store the second image in the one or more memories, and wherein to generate the second HDR image based on the third image and the second image, the processing circuitry is configured to: access the second image from the one or more memories; and reuse the second image used for generating the first HDR image to generate the second HDR image based on the second image and the third image.

Clause 9B. The device of any of clauses 1B-8B, wherein to receive the second image, the processing circuitry is configured to readout the second image after reading out the first image.

Clause 10B. A method of image processing, the method comprising: receiving, with processing circuitry, a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receiving, with the processing circuitry, a second image generated with a second exposure duration, the second exposure duration being greater than the first exposure duration; generating, with the processing circuitry, a first high dynamic range (HDR) image based on the first image and second image; outputting, with the processing circuitry, the first HDR image; receiving, with the processing circuitry, a third image generated using the DCG mode with the first exposure duration; generating, with the processing circuitry, a second HDR image based on the third image and the second image; and outputting, with the processing circuitry, the second HDR image.

Clause 11B. The method of clause 10B, wherein the first image is an anchor image, and wherein generating the first HDR image comprises: determining that a first portion of image content in the anchor image is same as a corresponding first portion of image content in the second image; determining that a second portion of image content in the anchor image is different than a corresponding second portion of image content in the second image; and fusing the first portion of image content from the anchor image and the first portion of image content from second image and utilize the second portion of the anchor image to generate the first HDR image.

Clause 12B. The method of any of clauses 10B and 11B, wherein the third image is an anchor image, and wherein generating the second HDR image comprises: determining that a first portion of image content in the anchor image is same as a corresponding first portion of image content in the second image; determining that a second portion of image content in the anchor image is different than a corresponding second portion of image content in the second image; and fusing the first portion of image content from the anchor image and the first portion of image content from second image and utilize the second portion of the anchor image to generate the third HDR image.

Clause 13B. The method of any of clauses 10B-12B, wherein the second image is generated using a third level of gain.

Clause 14B. The method of clause 13B, wherein the third level of gain is equal to the first level of gain.

Clause 15B. The method of any of clauses 10B-14B, wherein the first image and the second image are captured over a first frame time, and wherein the third image is captured over a second frame time after the first frame time.

Clause 16B. The method of any of clauses 10B-15B, further comprising: generating, with an image sensor, the first gain image with the first exposure duration based on providing the first level of gain to output of photodiodes of the image sensor; generating, with the image sensor, the second gain image with the first exposure duration based on providing the second level of gain to output of the photodiodes of the image sensor; and generating, with the image sensor, the first image based on the first gain image and the second gain image.

Clause 17B. The method of any of clauses 10B-16B, further comprising storing the second image in one or more memories, wherein generating the second HDR image based on the third image and the second image comprises: accessing the second image from the one or more memories; and reusing the second image used for generating the first HDR image to generate the second HDR image based on the second image and the third image.

Clause 18B. Non-transitory computer-readable storage media storing instructions thereon that when executed cause one or more processors to: receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image; receive a second image generated with a second exposure duration, the second exposure duration being greater than the first exposure duration; and generate a first high dynamic range (HDR) image based on the first image and second image; output the first HDR image; receive a third image generated using the DCG mode with the first exposure duration; generate a second HDR image based on the third image and the second image; and output the second HDR image.

Clause 19B. The non-transitory computer-readable storage media of clause 18B, wherein the first image is an anchor image, and wherein the instructions that cause the one or more processors to generate the first HDR image comprise instructions that cause the one or more processors to: determine that a first portion of image content in the anchor image is same as a corresponding first portion of image content in the second image; determine that a second portion of image content in the anchor image is different than a corresponding second portion of image content in the second image; and fuse the first portion of image content from the anchor image and the first portion of image content from second image and utilize the second portion of the anchor image to generate the first HDR image.

Clause 20B. The non-transitory computer-readable storage media of any of clauses 18B and 19B, further comprising instructions that cause the one or more processors to store the second image in one or more memories, and wherein the instructions that cause the one or more processors to generate the second HDR image based on the third image and the second image comprise instructions that cause the one or more processors to: access the second image from the one or more memories; and reuse the second image used for generating the first HDR image to generate the second HDR image based on the second image and the third image.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for image processing, the device comprising:
one or more memories; and
processing circuitry coupled to the one or more memories and configured to:
receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image;
receive a second image generated with a second exposure duration, the second exposure duration being greater than the first exposure duration;
generate a first high dynamic range (HDR) image based on the first image and second image;
output the first HDR image;
receive a third image generated using the DCG mode with the first exposure duration;
generate a second HDR image based on the third image and the second image; and
output the second HDR image.

2. The device of claim 1, wherein the first image is an anchor image, and wherein to generate the first HDR image, the processing circuitry is configured to:
determine that a first portion of image content in the anchor image is same as a corresponding first portion of image content in the second image;
determine that a second portion of image content in the anchor image is different than a corresponding second portion of image content in the second image; and
fuse the first portion of image content from the anchor image and the first portion of image content from second image and utilize the second portion of the anchor image to generate the first HDR image.

3. The device of claim 1, wherein the third image is an anchor image, and wherein to generate the second HDR image, the processing circuitry is configured to:
determine that a first portion of image content in the anchor image is same as a corresponding first portion of image content in the second image;
determine that a second portion of image content in the anchor image is different than a corresponding second portion of image content in the second image; and
fuse the first portion of image content from the anchor image and the first portion of image content from second image and utilize the second portion of the anchor image to generate the second HDR image.

4. The device of claim 1, wherein the second image is generated using a third level of gain.

5. The device of claim 4, wherein the third level of gain is equal to the first level of gain.

6. The device of claim 1, wherein the first image and the second image are captured over a first frame time, and wherein the third image is captured over a second frame time after the first frame time.

7. The device of claim 1, further comprising an image sensor, wherein the image sensor is configured to:
generate the first gain image with the first exposure duration based on providing the first level of gain to output of photodiodes of the image sensor;
generate the second gain image with the first exposure duration based on providing the second level of gain to output of the photodiodes of the image sensor; and
generate the first image based on the first gain image and the second gain image.

8. The device of claim 1, wherein the processing circuitry is further configured to store the second image in the one or more memories, and wherein to generate the second HDR image based on the third image and the second image, the processing circuitry is configured to:
access the second image from the one or more memories; and
reuse the second image used for generating the first HDR image to generate the second HDR image based on the second image and the third image.

9. The device of claim 1, wherein to receive the second image, the processing circuitry is configured to readout the second image after reading out the first image.

10. A method of image processing, the method comprising:
receiving, with processing circuitry, a first image generated using dual conversion gain (DCG) mode with a first exposure duration, the DCG mode including combining a first gain image generated using a first level of gain with the first exposure duration and a second gain image generated using a second level of gain with the first exposure duration to generate the first image;
receiving, with the processing circuitry, a second image generated with a second exposure duration, the second exposure duration being greater than the first exposure duration;
generating, with the processing circuitry, a first high dynamic range (HDR) image based on the first image and second image;
outputting, with the processing circuitry, the first HDR image;
receiving, with the processing circuitry, a third image generated using the DCG mode with the first exposure duration;
generating, with the processing circuitry, a second HDR image based on the third image and the second image; and
outputting, with the processing circuitry, the second HDR image.

11. The method of claim 10, wherein the first image is an anchor image, and wherein generating the first HDR image comprises:
determining that a first portion of image content in the anchor image is same as a corresponding first portion of image content in the second image;
determining that a second portion of image content in the anchor image is different than a corresponding second portion of image content in the second image; and
fusing the first portion of image content from the anchor image and the first portion of image content from second image and utilize the second portion of the anchor image to generate the first HDR image.

12. The method of claim 10, wherein the third image is an anchor image, and wherein generating the second HDR image comprises:
determining that a first portion of image content in the anchor image is same as a corresponding first portion of image content in the second image;
determining that a second portion of image content in the anchor image is different than a corresponding second portion of image content in the second image; and
fusing the first portion of image content from the anchor image and the first portion of image content from second image and utilize the second portion of the anchor image to generate the third HDR image.

13. The method of claim 10, wherein the second image is generated using a third level of gain.

14. The method of claim 13, wherein the third level of gain is equal to the first level of gain.

15. The method of claim 10, wherein the first image and the second image are captured over a first frame time, and wherein the third image is captured over a second frame time after the first frame time.

16. The method of claim 10, further comprising:
generating, with an image sensor, the first gain image with the first exposure duration based on providing the first level of gain to output of photodiodes of the image sensor;
generating, with the image sensor, the second gain image with the first exposure duration based on providing the second level of gain to output of the photodiodes of the image sensor; and
generating, with the image sensor, the first image based on the first gain image and the second gain image.

17. The method of claim 10, further comprising storing the second image in one or more memories, wherein generating the second HDR image based on the third image and the second image comprises:
accessing the second image from the one or more memories; and
reusing the second image used for generating the first HDR image to generate the second HDR image based on the second image and the third image.

18. Non-transitory computer-readable storage media storing instructions thereon that when executed cause one or more processors to:
receive a first image generated using dual conversion gain (DCG) mode with a first exposure duration, the DCG mode including combining a first gain image generated using a first level of gain with the first exposure duration and a second gain image generated using a second level of gain with the first exposure duration to generate the first image;
receive a second image generated with a second exposure duration, the second exposure duration being greater than the first exposure duration; and
generate a first high dynamic range (HDR) image based on the first image and second image;
output the first HDR image;
receive a third image generated using the DCG mode with the first exposure duration;
generate a second HDR image based on the third image and the second image; and
output the second HDR image.

19. The non-transitory computer-readable storage media of claim 18, wherein the first image is an anchor image, and wherein the instructions that cause the one or more processors to generate the first HDR image comprise instructions that cause the one or more processors to:
determine that a first portion of image content in the anchor image is same as a corresponding first portion of image content in the second image;
determine that a second portion of image content in the anchor image is different than a corresponding second portion of image content in the second image; and
fuse the first portion of image content from the anchor image and the first portion of image content from second image and utilize the second portion of the anchor image to generate the first HDR image.

20. The non-transitory computer-readable storage media of claim 18, further comprising instructions that cause the one or more processors to store the second image in one or more memories, and wherein the instructions that cause the one or more processors to generate the second HDR image based on the third image and the second image comprise instructions that cause the one or more processors to:
access the second image from the one or more memories; and
reuse the second image used for generating the first HDR image to generate the second HDR image based on the second image and the third image.
